(19) United States
(12) Patent Application Publication
(10) Pub. No.: US 2024/0419716 A1
(43) Pub. Date: Dec. 19, 2024

(54) DATA CLASSIFIER

(71) Applicant: Exiger Holdings, Inc., New York, NY (US)

(72) Inventors: Udara Senanayake, Aurora (CA); Miao Duan, Scarborough (CA)

(21) Appl. No.: 18/743,303

(22) Filed: Jun. 14, 2024

Related U.S. Application Data
(60) Provisional application No. 63/508,702, filed on Jun. 16, 2023.

(51) Int. Cl. G06F 16/35

(52) U.S. Cl. CPC G06F 16/358

(57) ABSTRACT

Examples described herein provide data classification. According to an aspect, a computer-implemented method includes receiving, by a processing device, a data classification request at a data classifier and generating, by the processing device, one or more variations of the data classification request as one or more variants. The computer-implemented method also includes applying, by the processing device, a first set of rules by the data classifier to determine a first type prediction for the one or more variants, and applying, by the processing device, a second set of rules by the data classifier to determine a second type prediction for the one or more variants. The computer-implemented method further includes comparing, by the processing device, the first type prediction with the second type prediction to determine a final type prediction as a data classification result.

### CROSS-REFERENCE TO RELATED APPLICATIONS

This application claims the benefit of U.S. Provisional Application No. 63/508,702 filed Jun. 16, 2023, entitled “Data Classifier” of which is incorporated herein by reference in its entirety.

### BACKGROUND

This disclosure generally relates to data resolution, and more particularly, to a data classifier for ambiguous data classification to trigger subsequent processing across a computer network associated with a plurality of sources.

Data processing can access various data sources that may be distributed across a network. Processing of data can include a chain of actions that varies depending on the type of data being processed. Some type information of the data may be known, while other types may be ambiguous. Making incorrect data classifications can lead to errant processing, increased network traffic, increased computer resource utilization, and/or trigger unnecessary or incorrect processing actions. Accurate determination of type classification while processing associated data can prevent errant actions and excess consumption of computing resources, memory resources, and/or network traffic in a distributed system.

### SUMMARY

In one exemplary embodiment, a computer-implemented method for data classification is provided. The computer-implemented method includes receiving, by a processing device, a data classification request at a data classifier and generating, by the processing device, one or more variations of the data classification request as one or more variants. The computer-implemented method also includes applying, by the processing device, a first set of rules by the data classifier to determine a first type prediction for the one or more variants, and applying, by the processing device, a second set of rules by the data classifier to determine a second type prediction for the one or more variants. The computer-implemented method further includes comparing, by the processing device, the first type prediction with the second type prediction to determine a final type prediction as a data classification result.

In another exemplary embodiment, a system includes a memory with computer readable instructions and a processing device for executing the computer readable instructions. The computer readable instructions control the processing device to perform operations including receiving a data classification request at a data classifier, generating one or more variations of the data classification request as one or more variants, applying a first set of rules by the data classifier to determine a first type prediction for the one or more variants, applying a second set of rules by the data classifier to determine a second type prediction for the one or more variants, and comparing the first type prediction with the second type prediction to determine a final type prediction as a data classification result.

In a further exemplary embodiment, a computer-implemented method for testing a data classifier is provided. The computer-implemented method includes executing, by a processing device, a test set that provides a predetermined list of data classifications to the data classifier after an update to one or more rules or weights within the data classifier, and determining, by the processing device, whether a result set of the test set was improved as compared to a previous version of the data classifier. The computer-implemented method also includes adjusting, by the processing device, one or more of the rules or weights within the data classifier based on determining that the result set was unimproved compared to the previous version of the data classifier, and releasing, by the processing device, the data classifier with the update to one or more rules or weights for use based on determining that the result set was improved compared to the previous version of the data classifier.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a processing system for data classification according to one or more embodiments described herein;

FIG. 2 depicts a flow diagram of data classifier interactions according to one or more embodiments described herein;

FIGS. 3A and 3B depict user interfaces of a data classifier for a single prediction and a batch prediction according to one or more embodiments described herein;

FIG. 4 is a flow diagram of a data classifier according to one or more embodiments described herein;

FIG. 5 is a flow diagram of interactions based on data classification results according to one or more embodiments described herein;

FIG. 6 is a flow diagram of a method for data classification according to one or more embodiments described herein;

FIG. 7 is a flow diagram of testing a data classifier according to one or more embodiments described herein;

FIG. 8 is a flow diagram of a method for testing a data classifier according to one or more embodiments described herein; and

FIG. 9 is a block diagram of a processing system according to one or more embodiments described herein.

The diagrams depicted herein are illustrative. There can be many variations to the diagram or the operations described therein without departing from the scope of the embodiments described herein. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

One or more embodiments described herein relate to data classification and, more particularly, to a data classifier for ambiguous data classification to trigger subsequent processing across a computer network associated with a plurality of sources.

Data processing systems may interact with large volumes of data that may not be labeled. Some types of data are more likely to have ambiguity, particularly where multiple languages and abbreviations may be used. Identifying ambiguous data can trigger a series of interactions that are type specific. However, if the type is incorrectly classified, many additional processes and interactions may be invoked that would not otherwise happen. Further, misclassification errors may propagate through multiple systems and across network components, making associated error correction technically challenging. Issues associated with correctly determining a data classification of unlabeled and ambiguous data are significant and can be difficult to analyze. Processing of the data and associated classification may not be performed directly by humans, as the volume of data and throughput demand to use results of the analysis can exceed human capacity to process the data. Further, data can be provided in batches that are impractical for a human to manually separate.

The term “type” can refer to a classification scheme where the data has an intended meaning and can be operated upon differently depending upon classification. For example, a type can be entity type data that may be further decomposed into a person name, a company name, a geographic location name, etc. As another example, a numerical value may be interpreted as a phone number, a fax number, an identification number, etc. To the extent that the terms “data” and “type” are used herein, the use of these terms is distinguishable from the general computer programming use of the term “data type”, such as an integer, Boolean, string, floating-point, etc.

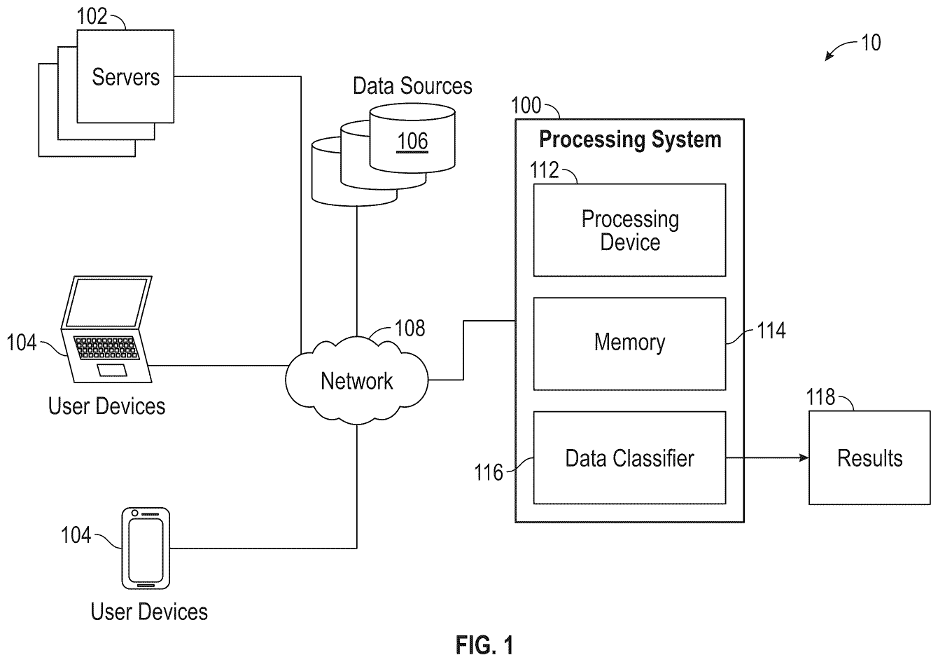

Turning now to FIG. 1, a system 10 is depicted in accordance with one or more embodiments. The system 10 includes a processing system 100 that can interact with one or more servers 102, user devices 104, and data sources 106 through a network 108. The processing system 100 can include a processing device 112 and memory 114. The memory 114 can include computer readable instructions. The processing device 112 can execute the computer readable instructions for controlling the processing device 112 to perform operations, such as executing a data classifier 116 to produce results 118.

The various components, modules, applications, classifiers, etc. described regarding FIG. 1 (e.g., the data classifier 116) can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the classifier(s) described herein can be a combination of hardware and programming. The programming can be processor executable instructions stored on a tangible memory, and the hardware can include the processing device 112 for executing those instructions. Thus, a system memory (e.g., memory 114) can store program instructions that when executed by the processing device 112 implement the classifier and other functions described herein. Other classifiers can also be utilized to include other features and functionality described in other examples herein. Further, aspects can be distributed between multiple processing devices and/or cloud computing based resources.

In one or more embodiments, the data classifier 116 can be implemented on the processing system 100 of FIG. 1. In one or more other embodiments, the data classifier 116 can be implemented, in whole or in part, using a cloud computing system (not shown). Cloud computing can supplement, support or replace some or all of the functionality of the elements of the processing system 100. Additionally, some or all of the functionality of the elements of the processing system 100 can be implemented as a cloud node of a cloud computing system.

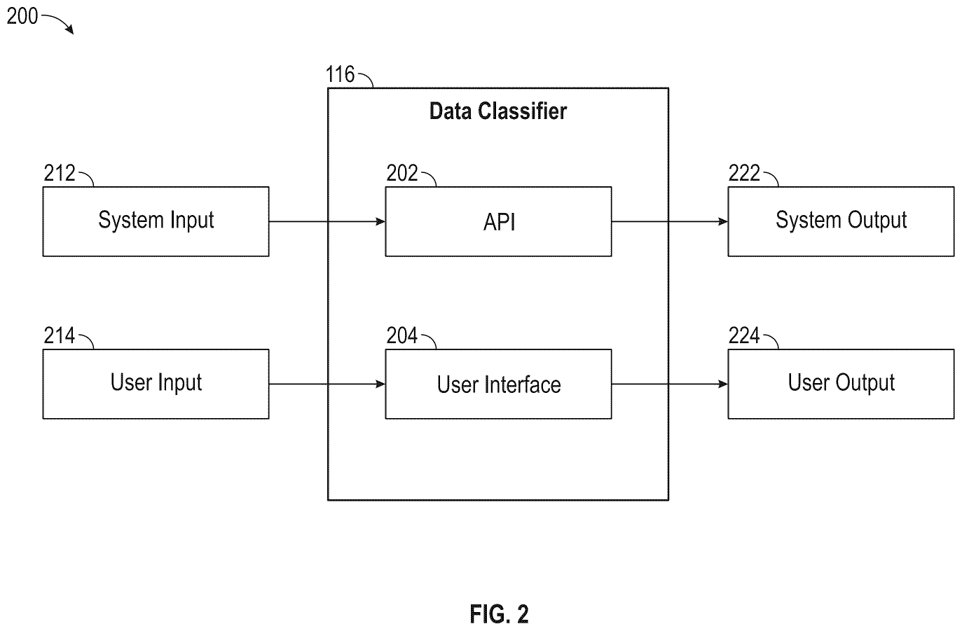

The data classifier 116 may be invoked by a request from the servers 102 and/or user devices 104. With respect to the data flow 200 of FIG. 2 and with continued reference to FIG. 1, the servers 102 can call an application programming interface (API) 202 of the data classifier 116 to process a system input 212 and generate a system output 222 as the results 118. For example, the system input 212 can be a post call (e.g., a hypertext transfer protocol (HTTP) post) with a payload to the API 202 seeking to confirm a type of a data value, e.g., text including one or more words. The system output 222 can include a response object formatted for consumption by an application or service initiating the request from the servers 102. In some aspects, the system output 222 can return an entity that aligns with the calling payload, a type result, a reason for the result, and, optionally, a confidence level. For example, where the data classifier 116 is configured to determine whether an entity name is a person name or a company name, the result for a payload of {“name”: “John Peter Smith” }, can be, for instance:

result:

```
{
  “entity”: “John Peter Smith”,
  “entity_type”: “Person”,
  “reason”: {‘person score: 0.6’: [‘person name freq (0.6) > company
  name freq (0.42)’],
‘company score: 0’: [ ]},
  “uncertain”: False
}.
```

Further, the API 202 may support batch processing, where the system input 212 can be a file or object from the data sources 106 of FIG. 1 as a list of data to be classified. Batch processing by the API 202 may include a preprocessing step to adjust formatting of the system input 212, for instance, to parse and separate multiple inputs into a format for data classification.

The data classifier 116 can also include a user interface 204 that receives user input 214, for instance, from one or more user devices 104 of FIG. 1. The data classifier 116 can generate user output 224 as results 118. The user output 224 can be displayed on the user interface 204 or may be stored to a file system, for example, where batch processing is requested by a user.

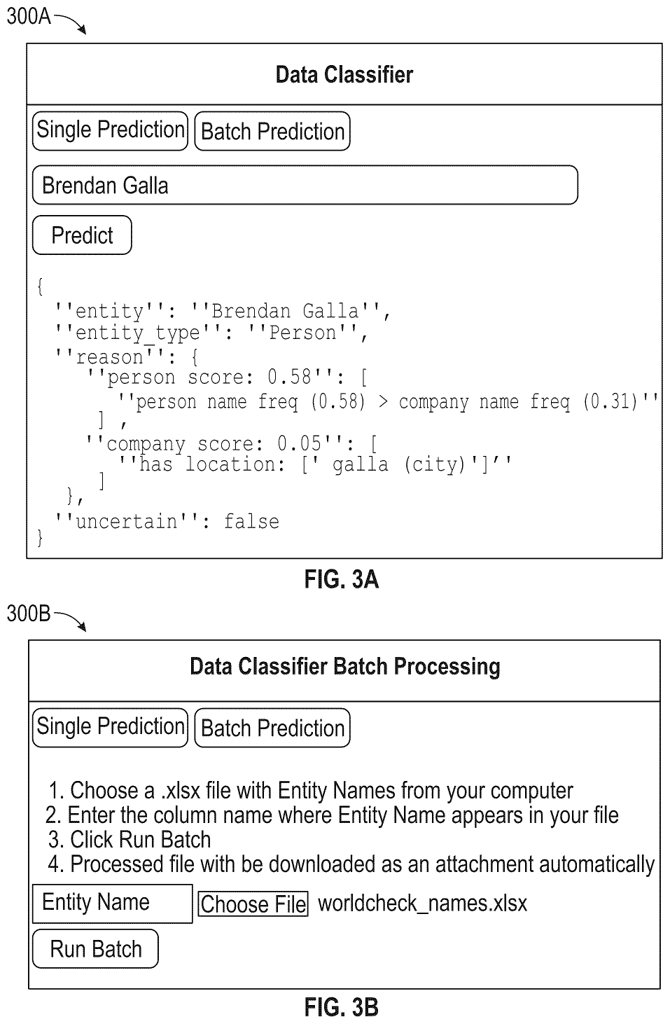

Turning now to FIGS. 3A and 3B, user interfaces 300A, 300B of the data classifier 116 are depicted for a single prediction and a batch prediction according to one or more embodiments. User interfaces 300A, 300B are examples of user interface 204 of FIG. 2. In the example of FIG. 3A, the user interface 300A is for a single prediction, where user input 214 of FIG. 2 may be entered through a dialog box. The user output 224 can appear on the user interface 300A after selecting a “predict” button. The user output 224 can include additional information in the output, such as scoring results for multiple potential types as a reason in combination with a confidence level.

The user interface 300B of FIG. 3B illustrates a batch prediction interface that can allow a user to select a file as the user input 214 of FIG. 2. The file can be available to a user device 104 and sent to the data classifier 116 or the file can be provided as a link accessible by the data classifier 116, for instance, on data sources 106. The user interface 300B can provide a dialogue box to input a column identifier of the data when user input 214 includes a spreadsheet or table format, for example. The results 118 can be provided as user output 224 as an automatically downloaded file, sent through a messaging system, or provided by other methods. Although the example of FIGS. 3A and 3B depict a possible implementation of the user interface 204, many other variations can be made within the scope of the disclosure.

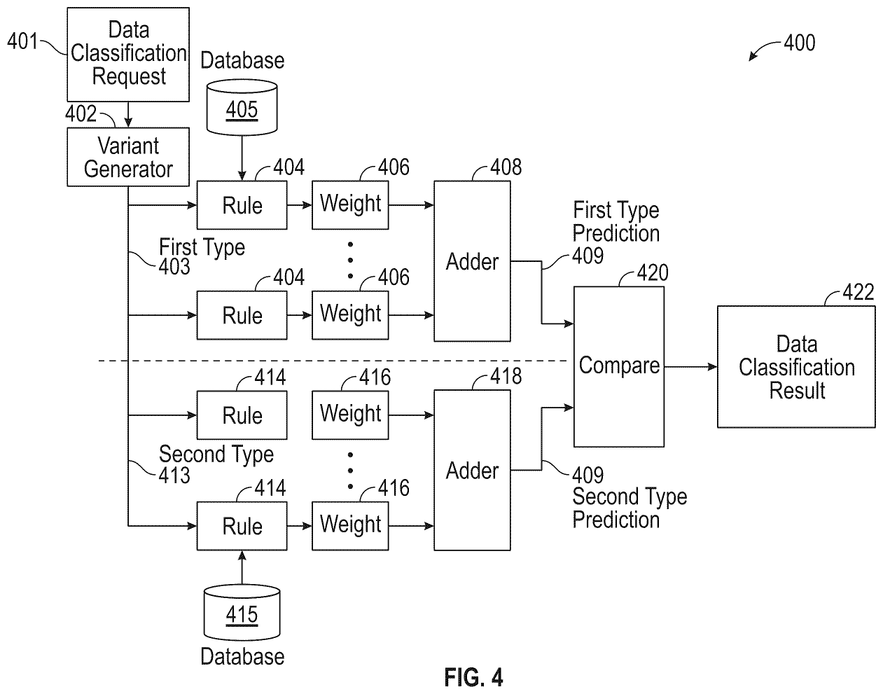

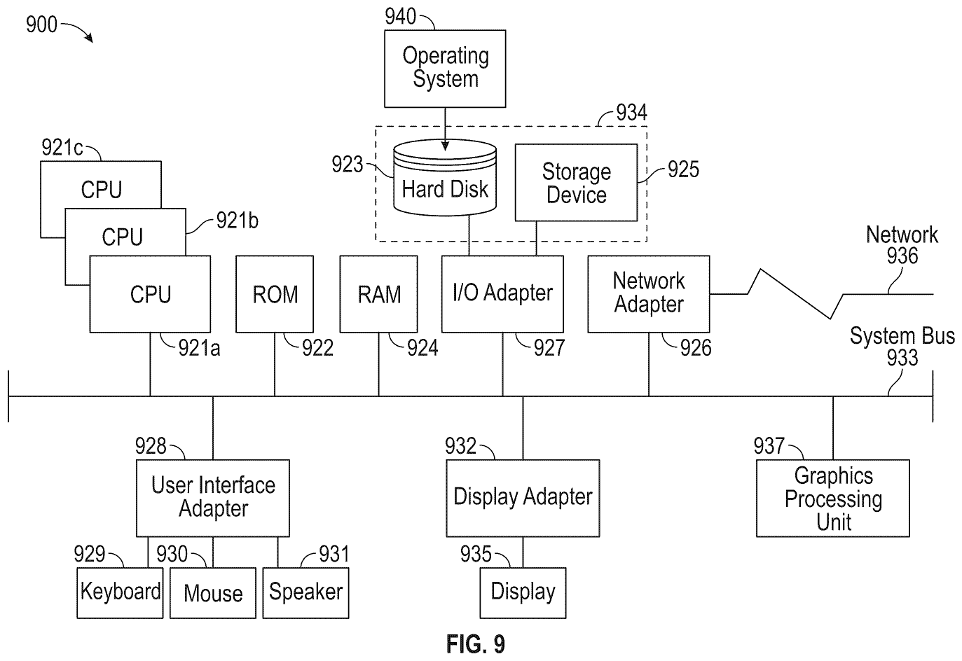

FIG. 4 is a flow diagram 400 of a data classifier, such as data classifier 116, according to one or more embodiments. The flow diagram 400 can be implemented by any suitable device or system, such as the processing system 100 of FIG. 1 and/or the processing system 900 of FIG. 9. In the example of FIG. 4, a data classification request 401 can be received as input, such as system input 212 or user input 214 of FIG. 2. A variant generator 402 can parse the data classification request 401 (e.g., into one or more tokens) and generate one or more variants of the data classification request 401 as one or more variants. As an example, in the context of foreign language processing and variant generation, an input of ΠAO “ [symbol] ” as the data classification request 401 can generate: 1. ΠAO “ [symbol] ”—entered name removing any extra spaces between tokens; 2. ΠAO “ [symbol] ”—to cleanup punctuation and/or extra spaces; and 3. PJSC Gazprom—transliterated name, cleanup punctuations, extra spaces. Unique variations can be retained while non-unique variations can be discarded. The original value of the data classification request 401 along with any unique variations can be passed as one or more variants for further analysis. The variants may be further decomposed into one or more tokens for analysis by sets of rules.

For example, the variants can be parsed into one or more tokens for a first type 403 to be processed by a first set of rules 404. A first set of weights 406 can be applied to at least one result of the first set of rules 404. For example, rules 404 can evaluate to a Boolean condition of true or false. When a rule evaluates to true, a corresponding weight of the first set of weights 406 can be sent to adder 408. Values received at adder 408 can be accumulated, where the total value represents a first type prediction 409. Similarly, the one or more tokens of the variants can be sent for a second type 413 to be processed by a second set of rules 414. A second set of weights 416 can be applied to at least one result of the second set of rules 414. For example, rules 414 can evaluate to a Boolean condition of true or false. When a rule evaluates to true, a corresponding weight of the second set of weights 416 can be sent to adder 418. Values received at adder 418 can be accumulated, where the total value represents a second type prediction 419. The first type prediction 409 and the second type prediction 419 can be compared by compare block 420, for instance, to determine which has a stronger indication (e.g., maximum value), and the corresponding value can be output as a data classification result 422. For instance, if the first type prediction 409 is greater than the second type prediction 419, then the data classification result 422 will identify the first type 403 as the type associated with the data classification request 401. The data classification result 422 can also include other information to assist in explaining the result, such as the values of the first type prediction 409, the second type prediction 419, and other such information. Where both of the first type prediction 409 and the second type prediction 419 are equal, one of the first type 403 or second type 413 can be selected as a default value.

The first set of rules 404 can evaluate different aspects as compared to the second set of rules 414. For example, where the first set of rules 404 is configured to determine a likelihood (e.g., a probability) that the data classification request 401 includes a name of a person, at least one rule of the first set of rules 404 can access a person name frequency database 405. Where the second set of rules 414 is configured to determine a likelihood (e.g., a probability) that the data classification request 401 includes a name of a company, at least one rule of the second set of rules 414 can access a company name frequency database 415. The person name frequency database 405 can be a separate resource from the company name frequency database 415. This separation can allow for faster processing time, as database access contention is reduced. In some aspects, two of more of the first set of rules 404 and/or the second set of rules 414 can be executed in parallel to reduce analysis delays. The person name frequency database 405 and/or the company name frequency database 415 can be a file (e.g., a JSON—JavaScript Object Notation file) with name tokens and frequencies.

Examples of the first set of rules 404 can include matching a high profile person name, use of language-specific letters, use of punctuation in specific languages, and/or use of the person name frequency from the person name frequency database 405. Examples of the second set of rules 414 can include matching a high profile company name, a located industry type, a located company term, a located company prefix, use of specific characters associated with a company name, use of hyphenation, use of characters deemed more likely to be company entity characters, prefixes, suffixes, language-specific tokens, singular names, a defined location, and other such patterns.

While the example of FIG. 4 includes groups of distinctly defined rules, in other aspects, rules can be learned through machine learning. A machine learning approach can include one or more neural networks, such as convolutional and/or deep learning networks, trained on a large corpus of training data. Training data can include the use of labeled and/or unlabeled data. Training can be performed using supervised or unsupervised training techniques. After training, the sets of rules are inherently defined within the trained networks. This can support defining associations that are not readily identifiable through a discrete list of rules. Where a machine learning approach is used, a low confidence result (e.g., below a minimum confidence threshold) can trigger the use of the sets of rules of FIG. 4 to determine whether other rules can make a higher confidence determination.

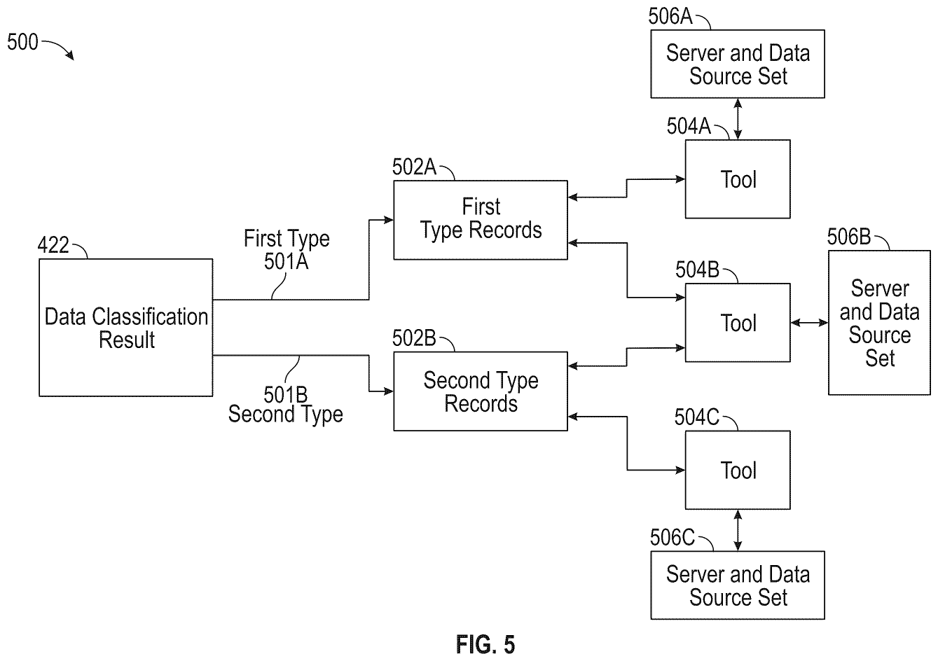

FIG. 5 is a flow diagram 500 of interactions based on data classification results according to one or more embodiments. The data classification result 422 from FIG. 4 can be split into different processing paths depending on whether the data classification result 422 has a first type 501A or whether the data classification result 422 has a second type 501B as the most likely type of the data classification request 401 of FIG. 4. Where the first type 501A is determined, results may be collected in first type records 502A that can differ from the second type 501B that may be collected in second type records 502B. Different tools and data sources may interact with the first type records 502A and the second type records 502B. For example, tool 504A may interact with the first type records 502A and server and data source set 506A. Tool 504B may interact with first type records 502A and the second type records 502B along with a shared set of resources in server and data source set 506B. Further, tool 504C may interact with the second type records 502B along with server and data source set 506C. Thus, an incorrect determination by the data classifier 116 can result in a chain of events where errant information may be propagated and shared with one or more systems as well as impacting other data sets associated with different servers and data source sets.

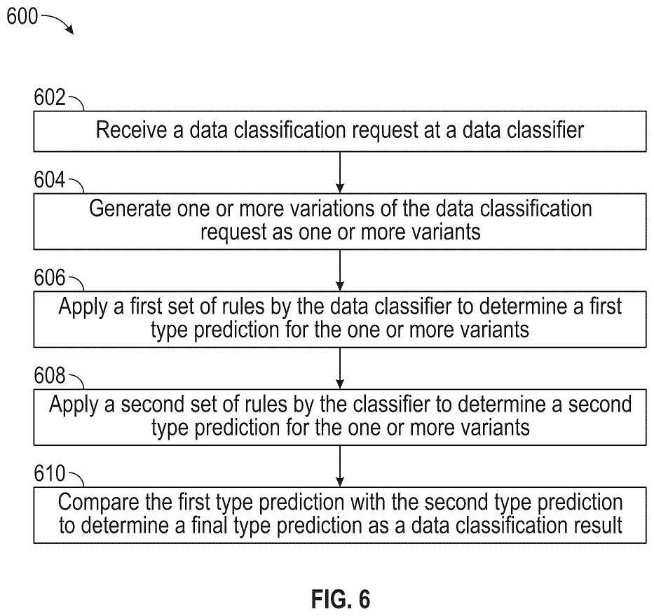

FIG. 6 is a flow diagram of a method 600 for data classification according to one or more embodiments described herein. The method 600 can be implemented by any suitable device or system, such as the processing system 100 of FIG. 1 and/or the processing system 900 of FIG. 9 as a computer-implemented method. For example, the method 600 can be performed by the processing device 112 executing computer readable instructions stored in the memory 114 to perform functions of the data classifier 116. The method 600 is described in reference to FIGS. 1-5.

At block 602, a data classification request 401 can be received at a data classifier 116. At block 604, the data classifier 116, executed by the processing device 112, can generate one or more variations of the data classification request 40 as one or more variants, for instance, using variant generator 402. At block 606, the data classifier 116, executed by the processing device 112, can apply a first set of rules 404 to determine a first type prediction 409 for the one or more variants. At block 608, the data classifier 116, executed by the processing device 112, can apply a second set of rules 414 to determine a second type prediction 419 for the one or more variants. At block 610, the data classifier 116, executed by the processing device 112, can compare (e.g., at compare block 420) the first type prediction 409 with the second type prediction 419 to determine a final type prediction as a data classification result 422.

According to some aspects, a first set of weights 406 can be applied to at least one result of the first set of rules 404, and a second set of weights 416 can be applied to at least one result of the second set of rules 414. At least one weight of the first set of weights 406 and at least one weight of the second set of weights 416 can be adjustable. The first type prediction 409 can be determined based on adding a first result subset of applying the first set of weights 406 to the at least one result of the first set of rules 404. The second type prediction 419 can be determined based on adding a second result subset of applying the second set of weights 416 to the at least one result of the second set of rules 414.

According to some aspects, the first set of rules 404 can be configured to determine a likelihood that the data classification request 401 includes a name of a person, and the second set of rules 414 can be configured to determine a likelihood that the data classification request 401 includes a name of a company. At least one rule of the first set of rules 404 can access a person name frequency database 405 and at least one rule of the second set of rules 414 accesses a company name frequency database 415.

According to some aspects, the data classifier 116 can be configurable between performing a single type prediction and a batch of type predictions. A user interface 204 of the data classifier 116 can output information associated with the first type prediction 409 and the second type prediction 419 with the data classification result 422.

Additional processes also may be included, and it should be understood that the process depicted in FIG. 6 represents an illustration, and that other processes may be added or existing processes may be removed, modified, or rearranged without departing from the scope of the present disclosure. For example, there can be any number of rule sets, e.g., two or more sets of rules, depending on how many classification types are supported.

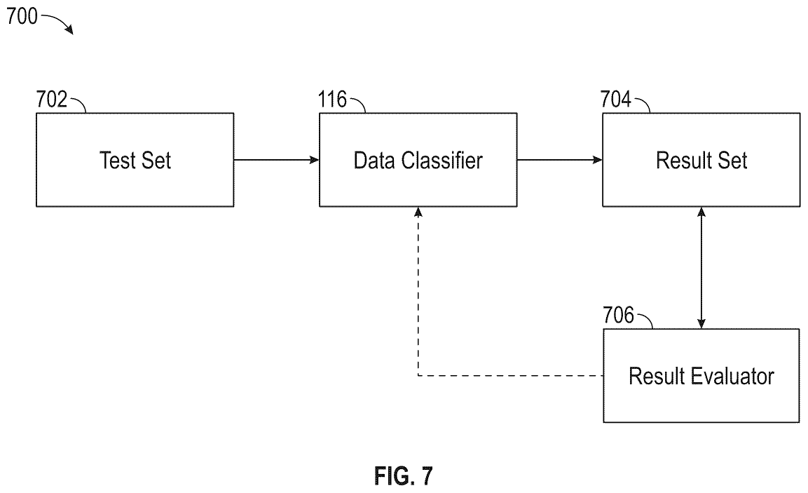

FIG. 7 is a flow diagram 700 of testing the data classifier 116 according to one or more embodiments. As updates are made to the rules and/or weights used by the data classifier 116, a test set 702 can be used to automate at least a portion of testing and verifying that updates to the data classifier 116 are an improvement over a previous version. The test set 702 can include standardized inputs as strings of one or more tokens in one or more languages to determine whether a result set 704 has a higher or lower scoring prediction performance as compared to a previous version of the data classifier 116. Here, prediction performance can include one or more of precision, recall and F1 score (e.g., harmonic mean of precision and recall). A “higher” score in this context means better performing regardless of whether the associated scores are numerically higher or lower. A result evaluator 706 can compare the result set 704 to expected values and determine one or more performance characteristics. In some aspects, the result evaluator 706 can highlight which test cases in the test set 702 resulted in a lower prediction performance score of the data classifier 116. Where the data classifier 116 performs multiple type predictions per data classification request, the result evaluator 706 can indicate which type scores differed between versions of the data classifier 116. Further, the results captured in the result set 704 may include the influence of specific rules in data classification results to assist in determining whether rules or weights should be adjusted. In some aspects, a process to tune weights can be at least partially automated for the result evaluator 706 to adjust one or more weights in the data classifier 116 to provide performance improvements over a previous version of the data classifier 116. Tuning of weights of the data classifier 116 may also be performed when new test cases are established for the test set 702.

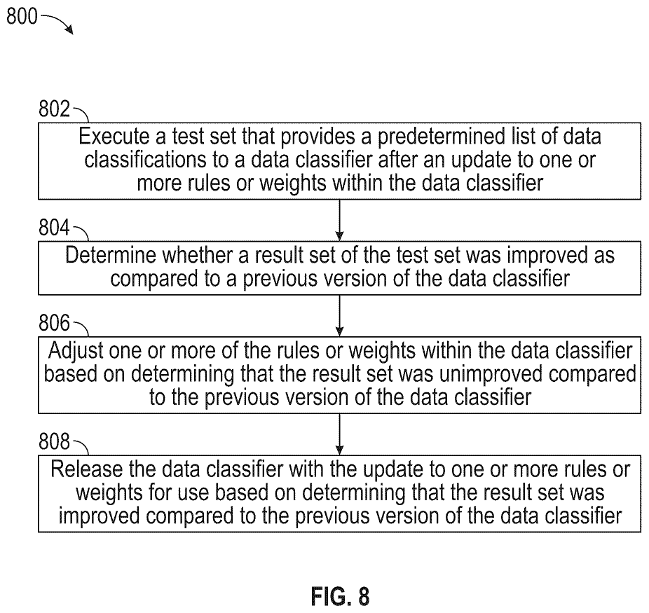

FIG. 8 is a flow diagram of a method 800 for testing the data classifier 116 according to one or more embodiments described herein. The method 800 can be implemented by any suitable device or system, such as the processing system 100 of FIG. 1 and/or the processing system 900 of FIG. 9 as a computer-implemented method. For example, the method 800 can be performed by the processing device 112 executing computer readable instructions stored in the memory 114 to perform functions of the data classifier 116 and/or the result evaluator 706. The method 800 is described with reference to FIG. 7.

At block 802, a test set 702 that provides a predetermined list of data classifications to the data classifier 116 can be executed after an update to one or more rules or weights within the data classifier 116. The test set 702 can include a plurality of words in two or more languages of a first type associated with a first type prediction of the data classifier 116 and a second type associated with a second type prediction of the data classifier 116.

At block 804, a result evaluator 706 can determine whether a result set 704 of the test set 702 was improved as compared to a previous version of the data classifier 116. Determining whether the result set 704 of the test set 702 was improved as compared to the previous version of the data classifier 116 can include comparing the result set 704 of the test set 702 and a previous result set of the previous version of the data classifier 116 to an expected result set and determining which had a higher prediction performance score.

At block 806, one or more of the rules or weights within the data classifier 116 can be adjusted based on determining that the result set 704 was unimproved compared to the previous version of the data classifier 116. Thus, if prediction performance is reduced after an update to the data classifier 116, the data classifier 116 can be adjusted and tested again (e.g., one or more times) to see if the prediction performance can be improved.

At block 808, the data classifier 116 with the update to one or more rules or weights can be released for use based on determining that the result set 704 was improved compared to the previous version of the data classifier 116. For example, updates to the rules and/or weights of the data classifier 116 can be performed in a development environment. Once updates are made and performance results are verified, the updated version of the data classifier 116 can be released in a production environment for use by other users and systems.

According to some aspects, result evaluator 706 can be configured to tune one or more of the weights within the data classifier 116 until the result set 704 has a higher prediction performance score than the previous version of the data classifier 116.

Additional processes also may be included, and it should be understood that the process depicted in FIG. 8 represents an illustration, and that other processes may be added or existing processes may be removed, modified, or rearranged without departing from the scope of the present disclosure.

Example embodiments of the disclosure include or yield various technical features, technical effects, and/or improvements to technology. Example embodiments of the disclosure provide data classification for ambiguous data. These aspects of the disclosure constitute technical features that yield the technical effect of rapid type classification in an efficient and effective way that cannot practically be performed in the human mind. As a result of these technical features and technical effects, a data classifier in accordance with example embodiments of the disclosure represents an improvement to data processing techniques. It should be appreciated that the above examples of technical features, technical effects, and improvements to technology of example embodiments of the disclosure are merely illustrative and not exhaustive.

It is understood that one or more aspects described herein is capable of being implemented in conjunction with any other type of computing environment now known or later developed. For example, FIG. 9 depicts a block diagram of a processing system 900 for implementing the techniques described herein. In examples, processing system 900 has one or more central processing units (“processors” or “processing resources” or “processing devices”) 921a, 921b, 921c, etc. (collectively or generically referred to as processor(s) 921 and/or as processing device(s)). In aspects of the present disclosure, each processor 921 can include a reduced instruction set computer (RISC) microprocessor. Processors 921 are coupled to system memory (e.g., random access memory (RAM) 924) and various other components via a system bus 933. Read only memory (ROM) 922 is coupled to system bus 933 and may include a basic input/output system (BIOS), which controls certain basic functions of processing system 900.

Further depicted are an input/output (I/O) adapter 927 and a network adapter 926 coupled to system bus 933. I/O adapter 927 may be a small computer system interface (SCSI) adapter that communicates with a hard disk 923 and/or a storage device 925 or any other similar component. I/O adapter 927, hard disk 923, and storage device 925 are collectively referred to herein as mass storage 934. Operating system 940 for execution on processing system 900 may be stored in mass storage 934. The network adapter 926 interconnects system bus 933 with an outside network 936 enabling processing system 900 to communicate with other such systems.

A display 935 (e.g., a display monitor) is connected to system bus 933 by display adapter 932, which may include a graphics adapter to improve the performance of graphics intensive applications and a video controller. In one aspect of the present disclosure, adapters 926, 927, and/or 932 may be connected to one or more I/O busses that are connected to system bus 933 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 933 via user interface adapter 928 and display adapter 932. A keyboard 929, mouse 930, and speaker 931 may be interconnected to system bus 933 via user interface adapter 928, which may include, for example, a Super I/O chip integrating multiple device adapters into a single integrated circuit.

In some aspects of the present disclosure, processing system 900 includes a graphics processing unit 937. Graphics processing unit 937 is a specialized electronic circuit designed to manipulate and alter memory to accelerate the creation of images in a frame buffer intended for output to a display. In general, graphics processing unit 937 is very efficient at manipulating computer graphics and image processing, and has a highly parallel structure that makes it more effective than general-purpose CPUs for algorithms where processing of large blocks of data is done in parallel.

Thus, as configured herein, processing system 900 includes processing capability in the form of processors 921, storage capability including system memory (e.g., RAM 924), and mass storage 934, input means such as keyboard 929 and mouse 930, and output capability including speaker 931 and display 935. In some aspects of the present disclosure, a portion of system memory (e.g., RAM 924) and mass storage 934 collectively store the operating system 940 to coordinate the functions of the various components shown in processing system 900.

It is to be understood that the block diagram of FIG. 9 is not intended to indicate that the processing system 900 is to include all of the components shown in FIG. 9. Rather, the processing system 900 can include any appropriate fewer or additional components not illustrated in FIG. 9 (e.g., additional memory components, embedded controllers, modules, additional network interfaces, etc.). Further, the aspects described herein with respect to processing system 900 may be implemented with any appropriate logic, wherein the logic, as referred to herein, can include any suitable hardware (e.g., a processor, an embedded controller, or an application-specific integrated circuit, among others), software (e.g., an application, among others), firmware, or any suitable combination of hardware, software, and firmware, in various aspects.

In yet another exemplary embodiment a computer program product includes a computer readable storage medium having program instructions embodied therewith, where the computer readable storage medium is not a transitory signal per se, the program instructions executable by a processing device to cause the processing device to perform operations as disclosed above.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

The flowchart and block diagrams in the figures illustrate the architecture, functionality, and operation of possible implementations of systems, methods, and computer program products according to various embodiments described herein. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for data classification, the method comprising:
receiving, by a processing device, a data classification request at a data classifier;
generating, by the processing device, one or more variations of the data classification request as one or more variants;
applying, by the processing device, a first set of rules by the data classifier to determine a first type prediction for the one or more variants;
applying, by the processing device, a second set of rules by the data classifier to determine a second type prediction for the one or more variants; and
comparing, by the processing device, the first type prediction with the second type prediction to determine a final type prediction as a data classification result.

2. The computer-implemented method of claim 1, wherein a first set of weights is applied to at least one result of the first set of rules, and a second set of weights is applied to at least one result of the second set of rules.

3. The computer-implemented method of claim 2, wherein at least one weight of the first set of weights and at least one weight of the second set of weights are adjustable.

4. The computer-implemented method of claim 2, wherein the first type prediction is determined based on adding a first result subset of applying the first set of weights to the at least one result of the first set of rules, and the second type prediction is determined based on adding a second result subset of applying the second set of weights to the at least one result of the second set of rules.

5. The computer-implemented method of claim 1, wherein the first set of rules is configured to determine a likelihood that the data classification request comprises a name of a person, and the second set of rules is configured to determine a likelihood that the data classification request comprises a name of a company.

6. The computer-implemented method of claim 5, wherein at least one rule of the first set of rules accesses a person name frequency database and at least one rule of the second set of rules accesses a company name frequency database.

7. The computer-implemented method of claim 1, wherein the data classifier is configurable between performing a single type prediction and a batch of type predictions.

8. The computer-implemented method of claim 7, wherein a user interface of the data classifier outputs information associated with the first type prediction and the second type prediction with the data classification result.

9. A system comprising:
a memory comprising computer readable instructions; and
a processing device for executing the computer readable instructions, the computer readable instructions controlling the processing device to perform operations comprising:
receiving a data classification request at a data classifier;
generating one or more variations of the data classification request as one or more variants;
applying a first set of rules by the data classifier to determine a first type prediction for the one or more variants;
applying a second set of rules by the data classifier to determine a second type prediction for the one or more variants; and
comparing the first type prediction with the second type prediction to determine a final type prediction as a data classification result.

10. The system of claim 9, wherein a first set of weights is applied to at least one result of the first set of rules, and a second set of weights is applied to at least one result of the second set of rules.

11. The system of claim 10, wherein at least one weight of the first set of weights and at least one weight of the second set of weights are adjustable.

12. The system of claim 10, wherein the first type prediction is determined based on adding a first result subset of applying the first set of weights to the at least one result of the first set of rules, and the second type prediction is determined based on adding a second result subset of applying the second set of weights to the at least one result of the second set of rules.

13. The system of claim 9, wherein the first set of rules is configured to determine a likelihood that the data classification request comprises a name of a person, and the second set of rules is configured to determine a likelihood that the data classification request comprises a name of a company.

14. The system of claim 13, wherein at least one rule of the first set of rules accesses a person name frequency database and at least one rule of the second set of rules accesses a company name frequency database.

15. The system of claim 9, wherein the data classifier is configurable between performing a single type prediction and a batch of type predictions.

16. The system of claim 15, wherein a user interface of the data classifier outputs information associated with the first type prediction and the second type prediction with the data classification result.

17. A computer-implemented method for testing a data classifier, the method comprising:
executing, by a processing device, a test set that provides a predetermined list of data classifications to the data classifier after an update to one or more rules or weights within the data classifier;
determining, by the processing device, whether a result set of the test set was improved as compared to a previous version of the data classifier;
adjusting, by the processing device, one or more of the rules or weights within the data classifier based on determining that the result set was unimproved compared to the previous version of the data classifier; and
releasing, by the processing device, the data classifier with the update to one or more rules or weights for use based on determining that the result set was improved compared to the previous version of the data classifier.

18. The computer-implemented method of claim 17, wherein a result evaluator is configured to tune one or more of the weights within the data classifier until the result set has a higher prediction performance score than the previous version of the data classifier.

19. The computer-implemented method of claim 17, wherein the test set comprises a plurality of words in two or more languages of a first type associated with a first type prediction of the data classifier and a second type associated with a second type prediction of the data classifier.

20. The computer-implemented method of claim 17, wherein determining whether the result set of the test set was improved as compared to the previous version of the data classifier comprises comparing the result set of the test set and a previous result set of the previous version of the data classifier to an expected result set and determining which had a higher prediction performance score.
